(19) United States
(12) Patent Application Publication
(10) Pub. No.: US 2003/0009531 A1
(43) Pub. Date: Jan. 9, 2003

(54) Data Caching

(76) Inventors: James N. Richmann, Lewes, DE (US); David Wruck, Clarksville, MD (US); Eric V. Smith, Kensington, MD (US)

Correspondence Address: BRIAN J. COLANDREO, Fish & Richardson P.C., 225 Franklin Street, Boston, MA, 02110-2804, US

(21) Appl. No.: 10/164,155

(22) Filed: Jun. 6, 2002

Related U.S. Application Data
(60) Provisional application No. 60/296,616, filed on Jun. 7, 2001.

(51) Int. Cl. G06F 15/167

(52) U.S. Cl. 709/213

(57) ABSTRACT

A data caching process, residing on a server, for filtering and storing data, includes a data input process for receiving topic-specific data from a data stream. The topic-specific data relates to a user-defined topic. A content filtering process filters the topic-specific data in accordance with one or more user-defined parameters. This generates filtered, topic-specific data. A storage process stores the filtered, topic-specific data in one or more memory caches associated with the user-defined topic. An information distribution process distributes the filtered, topic-specific data to a subscriber.

### RELATED APPLICATIONS

This application claims the priority of U.S. Provisional Patent Application No. 60/296,616, filed on Jun. 7, 2001, and entitled “Web Cache That Provides Data on a Query/Response or Publishing Basis.”

### BACKGROUND

This invention relates to data caching. Content providers and data sources broadcast streaming data over a network (e.g., wired, optical, RF, etc.) to subscribers and users. Examples of this streaming data include: message-based news feeds or streams; stock information; sales figures, and so forth As the amount of data available is vast and this data is provided at high bandwidths, these data streams must be processed, filtered, and stored in order to make them manageable.

### SUMMARY

According to an aspect of this invention, a data caching process, which resides on a server, filters and stores data. A data input process receives topic-specific data from a data stream. This topic-specific data relates to a user-defined topic. A content filtering process filters the topic-specific data in accordance with one or more user-defined parameters, generating filtered, topic-specific data. A storage process stores the filtered, topic-specific data in one or more memory caches associated with the user-defined topic. These memory caches are located on a storage device. An information distribution process distributes the filtered, topic-specific data to a subscriber.

According to a further aspect of this invention, a data caching method for filtering and storing data, includes receiving topic-specific data from a data stream. This topic-specific data relates to a user-defined topic. The topic-specific data is filtered in accordance with one or more user-defined parameters. This generates filtered, topic-specific data, which is stored in one or more memory caches associated with the user-defined topic, and distributed to a subscriber.

According to a further aspect of this invention, a computer program product resides on a computer readable medium and has a plurality of instructions stored thereon. When executed by the processor, these instructions cause the processor to receive topic-specific data from a data stream. This topic-specific data relates to a user-defined topic. The topic-specific data is filtered in accordance with one or more user-defined parameters. This generates filtered, topic-specific data, which is stored in one or more memory caches associated with the user-defined topic, and distributed to a subscriber.

One or more of the following features may also be included. The data stream may be a single-topic data stream that only contains data relating to the user-defined topic. The data input process is configured to process the single-topic data stream and provide the topic-specific data to the content filtering process.

The data stream may be a topic-specific portion of a multi-topic data stream, which only contains data relating to the user-defined topic. The data input process is configured to process the topic-specific portion of the multi-topic data stream and provide the topic-specific data to the content filtering process.

The data stream may be a multi-topic data stream that contains data relating to multiple topics including the user-defined topic. The data input process includes a topic filtering process configured to block data that is not related to the user-defined topic and provide the topic-specific data to the content filtering process.

The topic-specific data includes one or more discrete messages and each discrete message includes one or more discrete data fields. The content filtering process includes a filter definition process for allowing a user of the process to define the user-defined parameters. These user-defined parameters define an acceptable value for any discrete data field. The content filtering process includes a field comparison process for comparing the actual value of any discrete data field in a message to the acceptable value for that discrete field to determine whether the actual value of a discrete data field is acceptable or unacceptable.

The content filtering process includes a message blocking process, responsive to the field comparison process determining that the actual value of a discrete data field is unacceptable, for blocking the message with the discrete data field having an unacceptable actual value. The content filtering process includes a message passing process, responsive to the field comparison process determining that the actual value of a discrete data field is acceptable, for providing the message with the discrete data field having an acceptable actual value to the storage process.

The information distribution process includes a data transmission process for transmitting the topic-specific data to the subscriber. The information distribution process includes a data broadcasting process, that includes: a data encoding process for encoding the topic-specific data into a topic-specific data stream; and a data streaming process for broadcasting the topic-specific data stream to the subscriber. The information distribution process includes a data retrieval process that allows a subscriber to access the topic-specific data. The data retrieval process includes a graphical user interface (e.g., a web browser) that allows the subscriber to interface with and operate the data retrieval process from a remote computer.

A message delay process delays the storage of the filtered, topic-specific data onto the memory caches for a defined period of time. A message calculation/modification process generates calculated data fields and inserts them into the filtered, topic-specific data.

According to a further aspect of this invention, a data caching method for filtering and storing data includes receiving topic-specific data from a data stream. This topic-specific data relates to a user-defined topic. The topic-specific data is filtered in accordance with one or more user-defined parameters. This generates filtered, topic-specific data, which is stored in one or more memory caches associated with the user-defined topic, and distributed to a subscriber.

One or more of the following features may also be included. The data stream is a single-topic data stream that only contains data relating to the user-defined topic. Receiving topic-specific data includes processing the single-topic data stream and providing the topic-specific data to the filtering the topic-specific data.

The data stream is a topic-specific portion of a multi-topic data stream, which only contains data relating to the user-defined topic. Receiving topic-specific data includes processing the topic-specific portion of the multi-topic data stream and providing the topic-specific data to the filtering the topic-specific data.

The data stream is a multi-topic data stream that contains data relating to multiple topics including the user-defined topic. Receiving topic-specific data includes blocking data that is not related to the user-defined topic and providing the topic-specific data to the filtering the topic-specific data.

The topic-specific data includes one or more discrete messages, each of which includes one or more discrete data fields. Filtering the topic-specific data includes allowing a user of the process to define the user-defined parameters. These user-defined parameters define an acceptable value for any discrete data field.

Filtering the topic-specific data includes comparing the actual value of any discrete data field in a message to the acceptable value for that discrete field to determine whether the actual value of a discrete data field is acceptable or unacceptable. Filtering the topic-specific data includes blocking, if it is determined that the actual value of a discrete data field is unacceptable, the message containing the discrete data field having an unacceptable actual value. Filtering the topic-specific data includes providing, if it is determined that the actual value of a discrete data field is acceptable, the message containing the discrete data field having an acceptable actual value to the storing the filtered, topic-specific data. Distributing the filtered, topic-specific data includes transmitting the topic-specific data to the subscriber. Distributing the filtered, topic-specific data includes: encoding the topic-specific data into a topic-specific data stream; and broadcasting the topic-specific data stream to the subscriber. Distributing the filtered, topic-specific data includes allowing a subscriber to access the topic-specific data. Distributing the filtered, topic-specific data includes allowing the subscriber to interface with and operate the data retrieval process from a remote computer.

According to a further aspect of this invention, a computer program product resides on a computer readable medium and has a plurality of instructions stored thereon. When executed by the processor, these instructions cause the processor to receive topic-specific data from a data stream. This topic-specific data relates to a user-defined topic. The topic-specific data is filtered in accordance with one or more user-defined parameters. This generates filtered, topic-specific data, which is stored in one or more memory caches associated with the user-defined topic, and distributed to a subscriber.

One or more advantages can be provided from the above. By filtering the streaming data being broadcast within a data stream, large quantities of data can be processed and made more manageable. Further, the filtering of these data streams allows for the user of the system to tailor the messages they receive in accordance with their particular areas of interest. Thus, the user can receive concise, targeted data tailored to their specific likes and needs. Additionally, by storing the received messages on a storage device, the messages can be retrieved and reviewed whenever it is convenient for the user. And finally, this stored data can be provided to the users in a variety of fashions, such as: email attachments; a topic-specific data stream that broadcasts the stored messages to the user, or a manual retrieval process that allows the user to log in and manually retrieve or review the topic specific messages.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of a data caching process; and

FIG. 2 is a flow chart depicting a data caching method.

### DETAILED DESCRIPTION

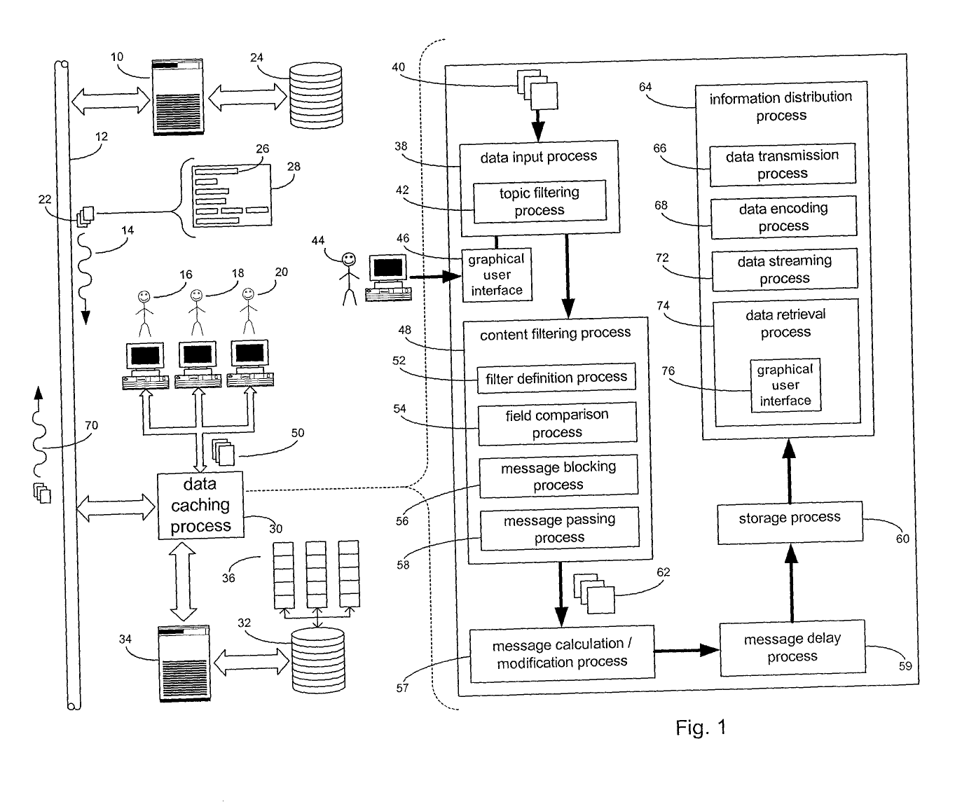

Referring to FIG. 1, data streams provide vast amounts of streaming data to subscribers and users. Typically, data streams tend to be content specific. For example, securities streams provide securities-related data, etc. Streaming data is broadcast from a server 10 residing on a distributed computing network 12. Server 10 provides a continuous data stream 14 that is transmitted over network 12 to subscribers and users 16, 18, and 20, which are also connected to network 12. Distributed computing network 12 can be the Internet, an intranet, a local area network, or any other form of network environment. The data 22 encoded into data stream 14 is stored on a storage device 24 of server 10. Storage device 24 could be a hard disk drive, a tape drive, an optical drive, a RAID array, a random access memory (RAM), or a read only memory (ROM).

Data streams may relate to a specific topic or may be multi-topic. For example, a message-based news stream typically provides messages in a variety of formats, such as: general news (a multi-topic news stream that provides messages on multiple topics); headline news (a single topic news stream, such that the topic is news headlines); political news (a single topic political news stream); business news (a single topic business news stream); etc. As stated above, these message-based news streams may be single or multi-topic. For message-based multi-topic news streams, the individual topics within the stream may be configured as individual channels. Therefore, the channel(s) that a user/subscriber selects determines the topic(s) of the messages they receive. An example of these message-based, multi-topic streams is a Tibco™ network data stream that is generated using Tibco™ Rendezvous 6.3.

Further, message-based data streams may contain messages concerning multiple topics broadcast over a single channel, such that each message specifies a topic within a data field of that message. For example, the format of the messages encoded within this type of data stream may be such that the first data field 26 within the message 28 always specifies the subject or topic of that message. Therefore, by filtering these messages in accordance with this first data field 26, the messages can be easily divided into topic-specific data stream.

Regardless of the type of data stream, data stream 14 is received by data caching process 30 that is also connected to network 12. Data caching process 30 resides on storage device 32 and is executed on server 34 (which is also connected to network 12). Process 30 can be a web-enabled process operating on a web-serving platform (e.g., Microsoft Internet Information Server™) running on server 34. Storage device 32 could be a hard disk drive, a tape drive, an optical drive, a RAID array, a random access memory (RAM), or a read only memory (ROM).

Upon receiving data stream 14, data caching process 30 filters the data 22 encoded into data stream 14 and stores desired portions of that data 22 in memory caches 36. These memory caches 36, which are located on storage device 32, can be either hardware or software-based temporary storage devices depending on the level of performance desired. For example, if maximum performance is desired, high-speed static RAM hardware-based memory caches can be used. Alternatively, if performance and access time is less critical, lower-speed dynamic RAM caches can be used. Further, if larger storage capacity is desired, each memory caches 36 can be configured as a directory on a hard drive.

Data caching process 30 can be used by a securities market (e.g., NYSE™, Nasdaq™, etc.) to filter and store securities-related message-based data streams. Alternatively, data caching process 30 can be used with any message-based data stream or message system. For example, process 30 can be used to filter and store messages posted in newsgroups.

A data input process 38 receives data 22 from data stream 14. As stated above, data 22 is typically topic-specific data 40, in that data stream 14 is most likely a single topic data stream or a single-topic channel of a multi-topic data stream. This topic-specific data 40 relates to a user-defined topic of interest to the users, subscribers, or administrators of process 30.

The specific user-defined topic can be defined in various ways, depending on the type of data stream(s) available. For example, if the data streams are single-topic data streams, the subscriber can define the topic(s) they are interested in by selecting which data streams to subscribe to. Therefore, the only data that the subscriber will receive is data related to the user-defined topic.

Alternatively, if the data stream available is a multi-topic data stream that is divided into multiple single-topic channels (or feeds), the subscriber can define the topic(s) they are interested in by selecting which channel(s) they subscribe to. This also results in the subscriber receiving only data related to the topics they define.

If the data stream available is a multi-topic stream that is not divided into channels, some preprocessing of data stream 14 has to occur to generate topic-specific data 40. Data input process 38 includes a topic filtering process 42. Topic filtering process 42 blocks those messages in a multi-topic data stream that are not related to the user-defined topic and allows those messages related to the user-defined topic to pass, thus converting multi-topic data into topic specific data 40.

As stated above, data stream 14 can be configured in several formats, such as: single-topic, single-channel; multi-topic, single-channel; and multi-topic, multi-channel, for example. Accordingly, data input process 38 is capable of receiving data stream 14 in various formats. Typically, data input process 38 is designed so that it is modular in nature, in that various modules are employed to convert the stream from the format in which it is broadcast into the format readable by data caching process 30. For example, if data caching process 30 is designed to process streams in format “Y” and the stream received is in format “A”, an “A→Y” module (i.e., data input process) would be employed to convert stream 14 from format “A” to format “Y”. Accordingly, data caching process 30 can be tailored and adapted by changing modules, eliminating the need to modify the core of the cache itself. These modules may be configured at runtime (requiring the cache to be restarted) or dynamically (eliminating the need to restart the cache).

Continuing with the above-stated example, if data stream 14 is a multi-topic, multi-channel stream and data caching process 30 can only process a single-topic, single-channel stream, the module (i.e., data input process) employed would allow the subscriber to define the topic they are interested in by selecting the appropriate channel. Therefore, data input process 38 would convert the multi-topic, multi-channel stream that was broadcast into a single-topic, single-channel stream readable by data caching process 30.

Another example of the modular nature of data input process 38 is exemplified when processing a multi-topic, single-channel stream. As described above, the conversion of a multi-topic data stream into a single topic data stream is accomplished by examining a predetermined field within the messages of the data stream. This requires that the person configuring topic filtering process 42 be knowledgeable of the structure of the data fields with the message. For example, if it is known that the messages within a securities data stream relating to traded securities contain five fields (e.g., the topic, the transmission date, the sender, the number of shares traded, and the trade price), topic filtering process 42 can be configured to perform topic-specific filtering. This configuration can be accomplished by a system administrator 44 using a graphical user interface 46 implemented through a web browser (e.g., Microsoft Internet Explorer™ or Netscape Navigator™) that interfaces with data caching process 30.

If administrator 44 wanted to configure process 30 to receive messages relating to a particular security and, for these messages, the first field of the message is “XYZ” name of a specific security, the administrator 44 would use interface 46 to configure topic filtering process 42 so that it passes all messages in which the first field is equal to “XYZ” and blocks any message in which the first field is something other than “XYZ”.

Topic filtering process 42 additionally supports all standard filtering parameters, such as the use of wild cards, “prefix” strings. “suffix” strings, “includes” strings, etc. Therefore, administrator 44 may define a filtering parameter of “XY*”, such that “*” is a wildcard and, therefore, any message with an entry in the first field that begins with “XY” would be passed and all other messages would be blocked.

As stated above, the field structure of incoming messages is generally known. Quite often, these messages include data that is not relevant to the targeted user/subscriber 16 of the stream 14. Further, as the sheer number of messages generated for broad topics can be quite large, it is often desirable to save only the portions of the message that are deemed relevant. Accordingly, if an incoming message stream provides messages that contain ten fields of data (i.e., fields A→J), of which only the first three fields (i.e., fields A→C) are relevant, administrator 44 can configure topic filtering process 42 (via interface 46) such that the irrelevant fields (i.e., fields D→J) are stripped from the message prior to it being saved. This, in turn, saves memory storage space on memory caches 36 As described above, the topic of topic specific data 40 is typically defined by administrator 44. Since these topics can be quite broad, they may result in a considerable number of messages. Therefore, process 30 includes a content filtering process 48 for filtering topic-specific data 40 in accordance with one or more user-defined parameters 50.

User-defined parameters 50 are similar to those specified by the administrator 44 when defining topic filtering process 42. These user-defined parameters 50 (which include wild cards, “prefix” strings. “suffix” strings, “includes” strings, etc.) are defined by users/subscribers 16, 18 and 20. Therefore, these user-defined parameters 50 specify additional filter parameters that define a secondary layer of filtering for the topic specific data 40. Continuing with the above-stated example in which the administrator defined a filter parameter of “XYZ”, if this produces a large number of message and the user/subscriber is only interested in messages concerning trades of more than one hundred shares, the user/subscriber can insert additional search terms that further filter the messages.

For this particular scenario, the user/subscriber can configure content filtering process 48 so that it searches field four, namely the “number of shares traded” field, to determine if the value of that field is greater than one hundred. If the value of this field is greater than one hundred, the message would be passed, and if the value of this field is less than or equal to one hundred, the message would be blocked. User I subscriber 16, 18, and 20 configures content filtering process 48 using a filter definition process 52 that allows the user/subscriber to define the field(s) to be examined and the values they are to be compared to. As data caching process 30 is a web-based process, filter definition process 52 is typically web-based and accessed using a web browser.

Content filtering process 48 includes a field comparison process 52 that compares the actual value of a data field within the message to an acceptable value for that data field, as defined by the user/subscriber using filter definition process 52. Field comparison process 54 determines whether the actual value of a discrete data field is acceptable or not. Continuing with the above-stated example where the user/subscriber is only interested in messages concerning the trade of greater than one hundred shares, the user/subscriber defines the field to be examined (i.e., field four) and the value to which it is to be compared (i.e., one hundred). Field comparison process 54 compares the actual value of the specified data field within each message (i.e., field four) to the acceptable value for that field (i.e., one hundred). If, for example, field four of a message examined had an actual value of eighty-seven (indicating that eight-seven shares were traded), field comparison process 54 would compare eighty-seven to one hundred and determine that the actual value is unacceptable. Therefore, this message needs to be blocked.

A message blocking process 56, responsive to field comparison process 54, blocks those messages that have a data field having an unacceptable actual value.

Alternatively, if the actual value of the field examined by field comparison process 54 is determined to be an acceptable value, a message passing process 58 allows the message to be passed to a storage process 60.

Prior to being stored by storage process 60, a message calculation/modification process 57 allows for the calculation of additional pieces of data (i.e., data fields) not originally included within the messages of data stream 14. Examples of these calculated pieces of data are: the total intraday volume of the entire market; the total intraday volume of a specific security; the percentage change of the entire market; the percentage change of a specific security; etc. Message calculation/modification process 57 typically inserts these calculated pieces of data into messages 28 as new data fields.

Additionally, a message delay process 59 can delay (if desired) the storage of the individual messages within memory caches 36. The amount of delay (if any) is configured by administrator 44. For example, if the messages to be stored in memory caches 36 pertain to the latest trading value for an individual security, if it is often desirable to provide trade values for free when they are delayed by, for example, twenty minutes. However, if the user/subscriber 16 desires real-time trade values, they are often required to pay a premium for this service. Accordingly, while the source of this trade information is the same, the “pay” stream would immediately be written to memory caches 36 and available to user/subscriber 16. However, the “free” stream would be configured by administrator 44 so that there is a defined delay (e.g., twenty minutes) before these trade values are written to the memory cache and, therefore, available to the user/subscriber 16.

While message delay process 59 is described above as delaying the writing of the individual messages to the cache, this is for illustrative purposes only. Specifically, it is foreseeable that the messages could be immediately written to the cache and their dissemination (e.g., retrieval from the cache, broadcast from the cache, etc.) could be delayed for a defined period of time.

Once any required calculations and field modifications are performed by message calculation/modification process 57 and any desired delays are instituted by message delay process 59, storage process 60 stores these messages (i.e., filtered topic-specific data 62) in one or more of the memory caches 36 (associated with the user-defined topic) located on storage device 32. As stated above, these memory caches temporarily store data for later retrieval. Depending on the filters designed by users/subscribers 16, 18, and 20 using filter definition process 48, these caches may be accessed by one or multiple users/subscribers. Additionally, as it is possible to have overlapping topics, it is possible for a single message to be stored in multiple caches. For example, if a first cache stored all messages relating to trades of IBM stock and a second cache stored all messages relating to trades of greater than one hundred shares of stock, if a trader traded two hundred shares of IBM stock, that trade message would be placed into both the first and the second memory caches.

Once these messages are stored in memory caches 36, an information distribution process 64 distributes this filtered, topic-specific data 62 stored on memory caches 36 to the users/subscribers 16, 18, and 20, of process 30. This information distribution process 64 is typically modular in nature, similar to that of data input process 38. Therefore, there are several types of information distribution processes 64 (or output modules), such that each type pertains to one of the possible retrieval methods for the messages stored in memory caches 36. For example, if administrator 44 would like the stored messages to be broadcast, a “broadcast” output module can be used. Alternatively, if the administrator wants these messages only retrievable via email, an email output module would be used. As with the data input process, these output modules may be configured at runtime (requiring the cache to be restarted) or dynamically (eliminating the need to restart the cache).

As stated above, this message distribution can occur in several ways, depending on the type of output module used. A data transmission process 66 can transmit filtered topic-specific data 62 to users/subscribers 16, 18, 20 as an email or an email attachment. Alternatively, this filtered topic-specific data 62 can be broadcast to the user/subscriber as a data stream 70. A data encoding process 68 encodes the filtered topic-specific data 62 into a topic-specific data stream 70 that is broadcast to the user/subscriber 16, 18, and 20 by a data streaming process 72. This topic-specific data stream can be produced using Tibco™ Rendezvous 6.3 or some other data streaming software.

Further, a data retrieval process 74 may be included that allows a user/subscriber 16, 18, and 20 to request and retrieve filtered, topic-specific data 62 stored on memory caches 36. Again, as process 30 is a web-based process, data retrieval process 74 is a web-based process in which the user/subscriber can retrieve the filtered topic-specific data 62 using a graphical user interface 76, such a Microsoft Internet Explorer™ or Netscape Navigator™. Typically, data retrieval process 74 allows user/subscriber 16 to make a request (e.g., a query, such as an HTTP form post command, an HTTP form get command, a formatted socket request, etc.) so that user subscriber 16 does not have to retrieve all of the filtered topic-specific data 62 stored on memory caches 36.

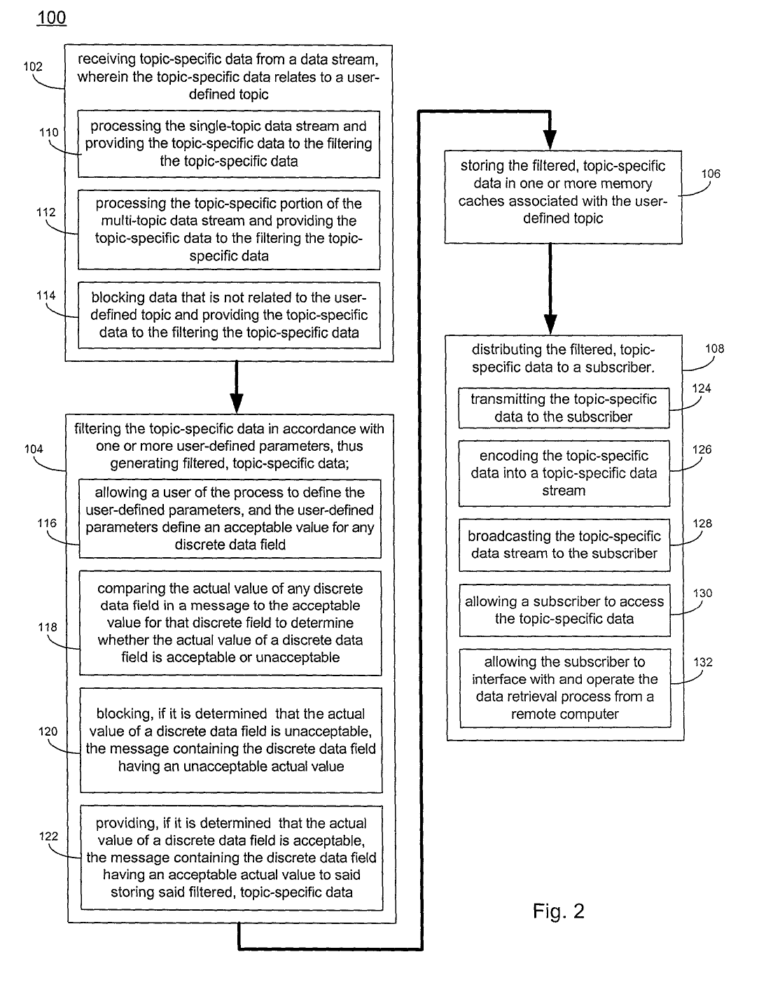

Referring to FIG. 2, a method 100 for filtering and storing data is shown. Topic-specific data is received 102 from a data stream. The topic-specific data relates to a user-defined topic. The topic-specific data is filtered 104 in accordance with one or more user-defined parameters. This generates filtered, topic-specific data. The filtered, topic-specific data is stored 106 in one or more memory caches associated with the user-defined topic. This filtered, topic-specific data is then distributed 108 to a subscriber.

The data stream is a single-topic data stream that has data relating to the user-defined topic. Receiving 102 topic-specific data includes processing 110 the single-topic data stream and providing the topic-specific data to the filtering 104 the topic-specific data.

The data stream is a topic-specific portion of a multi-topic data stream and the topic-specific portion of a multi-topic data stream has data relating to the user-defined topic. Receiving 102 topic-specific data includes processing 112 the topic-specific portion of the multi-topic data stream and providing the topic-specific data to the filtering 104 the topic-specific data.

The data stream is a multi-topic data stream that has data relating to multiple topics including the user-defined topic. Receiving 102 topic-specific data includes blocking 114 data that is not related to the user-defined topic and providing the topic-specific data to the filtering 104 the topic-specific data.

The topic-specific data comprises one or more discrete messages, and each discrete message includes one or more discrete data fields. Filtering 104 the topic-specific data includes allowing 116 a user of the process to define the user-defined parameters. These user-defined parameters define an acceptable value for any discrete data field. Filtering 104 the topic-specific data includes: comparing 118 the actual value of any discrete data field in a message to the acceptable value for that discrete field to determine whether the actual value of a discrete data field is acceptable or unacceptable.

Filtering 104 the topic-specific data includes blocking 120 messages containing discrete data fields having unacceptable actual values, and providing 122 messages containing the discrete data field having an acceptable actual value to the storing 106 the filtered, topic-specific data.

Distributing 108 the filtered, topic-specific data includes transmitting 124 the topic-specific data to the subscriber. Distributing 108 may also include encoding 126 the topic-specific data into a topic-specific data stream; and broadcasting 128 the topic-specific data stream to the subscriber, or allowing 130 a subscriber to access the topic-specific data. The subscriber is allowed 132 to interface with and operate the data retrieval process from a remote computer.

A number of embodiments of the invention have been described. Nevertheless, it will be understood that various modifications may be made without departing from the spirit and scope of the invention. Accordingly, other embodiments are within the scope of the following claims.

What is claimed is:

1. A data caching process, residing on a server, for filtering and storing data; comprising;
a data input process for receiving topic-specific data from a data stream, wherein said topic-specific data that relates to a user-defined topic;
a content filtering process for filtering said topic-specific data in accordance with one or more user-defined parameters, generating filtered, topic-specific data;
a storage process for storing said filtered, topic-specific data in one or more memory caches associated with said user-defined topic; and
an information distribution process for distributing said filtered, topic-specific data to a subscriber.

2. The data caching process of claim 1 wherein said data stream is a single-topic data stream that only contains data relating to said user-defined topic, and said data input process is configured to process said single-topic data stream and provide said topic-specific data to said content filtering process.

3. The data caching process of claim 2 wherein said data stream is a topic-specific portion of a multi-topic data stream, and said topic-specific portion of a multi-topic data stream only contains data relating to said user-defined topic, wherein said data input process is configured to process said topic-specific portion of the multi-topic data stream and provide said topic-specific data to said content filtering process.

4. The data caching process of claim 1 wherein said data stream is a multi-topic data stream that contains data relating to multiple topics including said user-defined topic, wherein said data input process includes a topic filtering process configured to block data that is not related to said user-defined topic and provide said topic-specific data to said content filtering process.

5. The data caching process of claim 1 wherein said topic-specific data comprises one or more discrete messages, wherein each discrete message includes one or more discrete data fields.

6. The data caching process of claim 5 wherein said content filtering process includes a filter definition process for allowing a user of the process to define said user-defined parameters, wherein said user-defined parameters define an acceptable value for any discrete data field.

7. The data caching process of claim 6 wherein said content filtering process includes a field comparison process for comparing the actual value of any discrete data field in a message to the acceptable value for that discrete field to determine whether the actual value of a discrete data field is acceptable or unacceptable.

8. The data caching process of claim 7 wherein said content filtering process include a message blocking process, responsive to said field comparison process determining that the actual value of a discrete data field is unacceptable, for blocking the message containing the discrete data field having an unacceptable actual value.

9. The data caching process of claim 7 wherein said content filtering process includes a message passing process, responsive to said field comparison process determining that the actual value of a discrete data field is acceptable, for providing the message containing the discrete data field having an acceptable actual value to said storage process.

10. The data caching process of claim 1 wherein said information distribution process includes a data transmission process for transmitting said topic-specific data to said subscriber.

11. The data caching process of claim 1 wherein said information distribution process includes a data broadcasting process including:
a data encoding process for encoding said topic-specific data into a topic-specific data stream; and
a data streaming process for broadcasting said topic-specific data stream to said subscriber.

12. The data caching process of claim 1 wherein said information distribution process includes a data retrieval process for allowing a subscriber to access said topic-specific data.

13. The data caching process of claim 12 wherein said data retrieval process includes a graphical user interface for allowing the subscriber to interface with and operate said data retrieval process from a remote computer.

14. The process of claim 13 wherein the graphical user interface is a web browser.

15. The process of claim 1 wherein said one or more memory caches are located on a storage device.

16. The process of claim 1 further comprising a message delay process for delaying the storage of said filtered, topic-specific data onto said one or more memory caches for a defined period of time.

17. The process of claim 1 further comprising a message calculation/modification process for generating at least one calculated data field and inserting said calculated data field into said filtered, topic-specific data.

18. A method for filtering and storing data in a data cache, the method comprising;
receiving topic-specific data from a data stream, wherein the topic-specific data relates to a user-defined topic;
generating filtered, topic-specific data by filtering the topic-specific data in accordance with one or more user-defined parameters;
storing the filtered, topic-specific data in one or more memory caches associated with the user-defined topic; and
distributing the filtered, topic-specific data to a subscriber.

19. The data caching method of claim 18 wherein the data stream is a single-topic data stream that only contains data relating to the user-defined topic, and said receiving topic-specific data includes processing the single-topic data stream and providing the topic-specific data to said filtering the topic-specific data.

20. The data caching method of claim 19 wherein the data stream is a topic-specific portion of a multi-topic data stream, and the topic-specific portion of a multi-topic data stream only contains data relating to the user-defined topic, wherein said receiving topic-specific data includes processing the topic-specific portion of the multi-topic data stream and providing the topic-specific data to said filtering the topic-specific data.

21. The data caching method of claim 18 wherein the data stream is a multi-topic data stream that contains data relating to multiple topics including the user-defined topic, wherein said receiving topic-specific data includes blocking data that is not related to the user-defined topic and providing the topic-specific data to said filtering the topic-specific data.

22. The data caching method of claim 18 wherein the topic-specific data comprises one or more discrete messages, and each discrete message includes one or more discrete data fields, wherein said filtering the topic-specific data includes allowing a user of the process to define the user-defined parameters, and the user-defined parameters define an acceptable value for any discrete data field.

23. The data caching method of claim 22 wherein said filtering the topic-specific data includes comparing the actual value of any discrete data field in a message to the acceptable value for that discrete field to determine whether the actual value of a discrete data field is acceptable or unacceptable.

24. The data caching method of claim 23 wherein said filtering the topic-specific data includes blocking, if it is determined that the actual value of a discrete data field is unacceptable, the message containing the discrete data field having an unacceptable actual value.

25. The data caching method of claim 23 wherein said filtering the topic-specific data includes providing, if it is determined that the actual value of a discrete data field is acceptable, the message containing the discrete data field having an acceptable actual value to said storing said filtered, topic-specific data.

26. The data caching method of claim 28 wherein said distributing said filtered, topic-specific data includes transmitting the topic-specific data to the subscriber.

27. The data caching method of claim 18 wherein said distributing the filtered, topic-specific data includes:
encoding the topic-specific data into a topic-specific data stream; and
broadcasting the topic-specific data stream to the subscriber

28. The data caching method of claim 18 wherein said distributing the filtered, topic-specific data includes allowing a subscriber to access the topic-specific data.

29. The data caching method of claim 28 wherein said distributing the filtered, topic-specific data includes allowing the subscriber to interface with and operate the data retrieval process from a remote computer.

30. A computer program product residing on a computer readable medium having a plurality of instructions stored thereon that, when executed by the processor, cause the processor to:
receive topic-specific data from a data stream, wherein the topic-specific data relates to a user-defined topic;
filter the topic-specific data in accordance with one or more user-defined parameters to generate filtered, topic-specific data;
store the filtered, topic-specific data in one or more memory caches associated with the user-defined topic; and
distribute the filtered, topic-specific data to a subscriber.
